(19) United States
(12) Patent Application Publication
(10) Pub. No.: US 2004/0003059 A1
(43) Pub. Date: Jan. 1, 2004

(54) Active key for wireless device configuration

(76) Inventor: Duncan M. Kitchin, Beaverton, OR (US)

Correspondence Address: FISH & RICHARDSON, PC, 12390 EL CAMINO REAL, SAN DIEGO, CA, 92130-2081, US

(21) Appl. No.: 10/183,152

(22) Filed: Jun. 26, 2002

(51) Int. Cl. G06F 15/177

(52) U.S. Cl. 709/220

(57) ABSTRACT

A key to configure a wireless device includes a non-volatile memory to store network configuration information including a unique network identifier. A circuit coupled to the non-volatile memory manages the network configuration information. An interface communicates data including the network configuration information with the wireless device.

### TECHNICAL FIELD

This invention relates to a configuration device to be used with a wireless network.

### BACKGROUND

Demand for wireless access to local area networks (LANs) has continued to increase with the growth of mobile devices such as laptop computers, personal digital assistants, cameras, email terminals, VCRs, and camcorders. With the increased growth in wireless LANs, there has been a corresponding increase in configuration concerns related to those wireless LANs, particularly related to security. Configuration information for current wireless devices that comply with the IEEE 802.11 standard, IEEE 802.11-1999 Wireless Package, includes the inputting of unique identifiers and cryptographic keys as well as several other parameters. The configuration information may be typically input by manual typing of the information using a keypad, menu system, touchscreen, or some other keyboard device. This information may include a long string of characters, to provide an adequate level of security. Manual inputting of the configuration information may be inconvenient.

### DESCRIPTION OF DRAWINGS

FIG. 1 is a block diagram of a wireless local area network.

FIG. 2 is a block diagram of a key interfaced to a wireless device.

FIG. 3 is a block diagram of another key interfaced to a wireless device.

FIG. 4 is a flow diagram of a key operation.

Like reference symbols in the various drawings indicate like elements.

### DETAILED DESCRIPTION

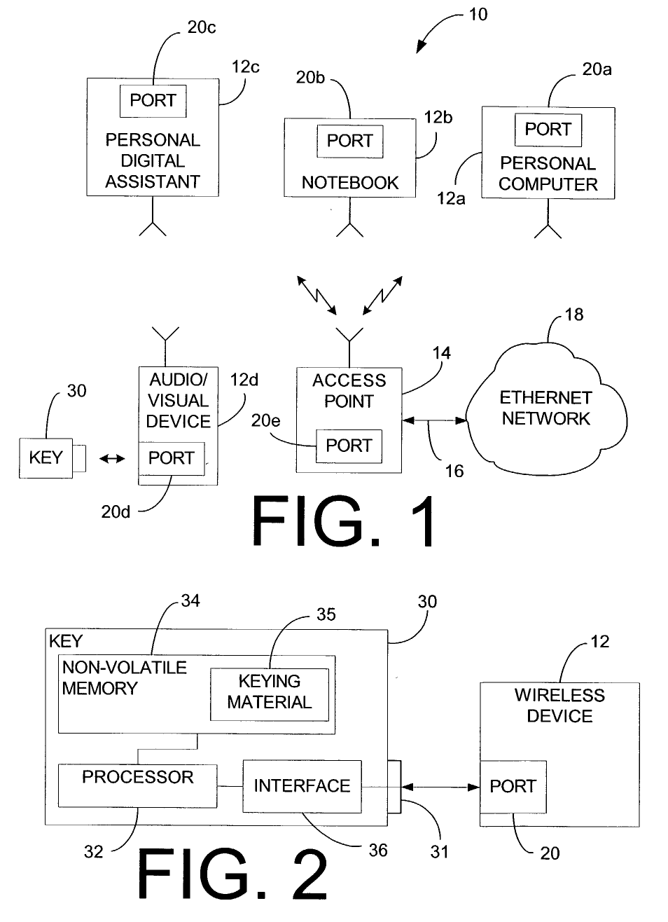

FIG. 1 shows a wireless local area network (WLAN) 10 interconnecting an access point 14 and several wireless devices 12a-12d. The access point 14 and each of the wireless devices 12a-12d include configuration information to provide secure communication over the WLAN. The configuration information may include identifiers, cryptographic keys, and keying material to be used as a starting point for negotiating a cryptographic key. The access point 14 may connect the WLAN 10 via a hardwire connection 16 with another network 18 such as the Internet or an Ethernet network. The WLAN 10 is a flexible communications system permitting wireless devices 12a-12d to communicate data over the air, minimizing the need for wired connections. Any communication mechanism or method may be used, including Code Division Multiple Access (CDMA), frequency hopping, orthogonal frequency division multiplexing (OFDM), infrared, and narrowband single frequency, although other methods may be used without limiting the present invention. The WLAN 10 may be implemented for a wide variety of functions including home interconnect, manufacturing, warehousing, health-care, retail, and academic arenas, among others.

Each of the wireless devices 12a-12d and the access point 14 may include a port 20a-20e for receiving keying material 35 that is stored within a key 30. The key 30 is adapted to interface to the ports 20a-20e and may be used to transmit the keying material to the wireless devices 12a-12d and the access point 14.

FIG. 2 shows a block diagram of the key 30. The key 30 may include a digital circuit such as a processor 32 to transfer the keying material. A non-volatile memory 34 may store the keying material 35 to be transferred to the wireless devices 12a-12d and a device program that may be executed by the processor 32.

The keying material 35 may be used directly as the cryptographic key or may be used as a starting point by a device 12 or 14 (FIG. 1) to negotiate a cryptographic key. The keying material 35 may be fixed, programmable, or part fixed/part programmable. Fixed keying material is stored permanently in the non-volatile memory 34. Fixed information may be stored during manufacture of the key 30, or may be programmed by interfacing the key 30 to a wireless device 12a-12d or access point 14. Fixed keying material is stored once in the key 30 and is not reprogrammed. Programmable keying material, in contrast, may be changed. The part fixed/part programmable keying material may include a portion which is changeable, with the remainder being fixed keying material.

A cryptographic key manager may be included in the device program to transfer the keying material 35 between the key 30 and the wireless device 12 or access point 14. The cryptographic key manager may alternatively be included in the access point 14 and wireless devices 12a-12d.

The key 30 may include a connector 31 to interface to a port 20 corresponding to a device on the WLAN. Any type of interface for communicating information may be employed to interface with the ports 20a-20e, including a serial port, Universal Serial Bus (USB), and Infrared (IR). As an example, a serial port interface may be implemented using a device configured as a door key with a connector and a “smart card” with an attached connector. The “smart card” may have a form factor similar to a credit card with onboard electronics. The key 30 is inserted into the port 20a-20e corresponding to the device to transmit keying material 35 to a device on the WLAN. The WLAN device may use the keying material 35 as a starting point to negotiate a cryptographic key with another WLAN device.

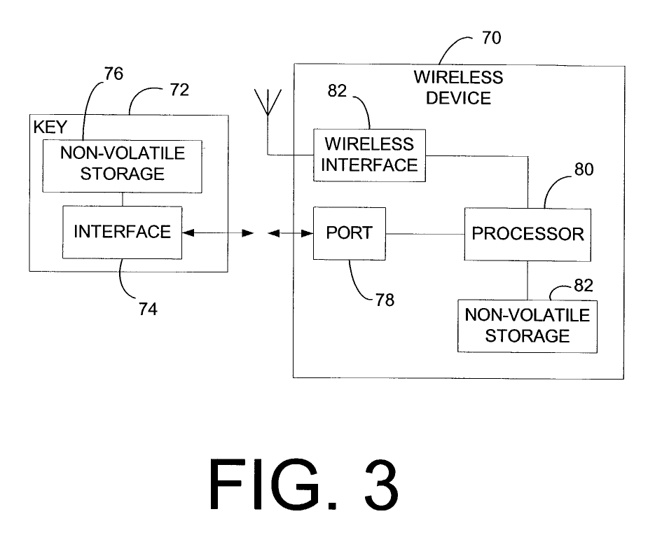

FIG. 3 shows a wireless device 70 coupled to another key 72 to communicate configuration information therebetween. The wireless device 70 may be included in a WLAN. The key 72 includes an interface 74 to couple to a port 78 of the wireless device 70. The interface 74 may be any type of interface for communicating information between the wireless device port 78 and the key 72. The interface 74 is connected to non-volatile storage 76 that may store fixed or programmable keying material, or both.

The wireless device 70 includes a processor 80 and nonvolatile storage 82 coupled to the port 78. The processor 80 may include a cryptographic key manager to transfer keying material between the key 72 and the wireless device 70. For example, if the key 72 includes complete keying material, the cryptographic key manager may manage the transfer of the keying material to the wireless device 70. If the key 72 includes either partial keying material or no keying material, the cryptographic key manager may transfer keying material from the wireless device 70 to the key 72 to generate complete keying material in the key 30. The wireless device keying material may be stored in the wireless device nonvolatile memory 76. A wireless interface 82 coupled to the processor facilitates communication with other wireless devices on the WLAN.

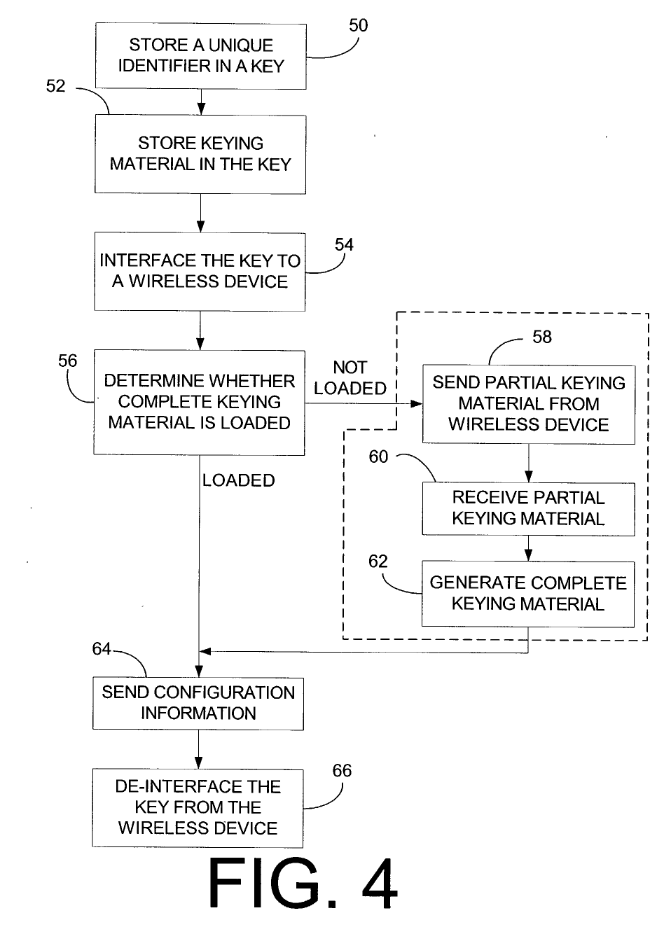

FIG. 4 shows a flow diagram of one aspect of a key process. During manufacture of a key a unique identifier may be stored in non-volatile memory at 50. The unique identifier may be a serial number or name corresponding to a specific WLAN that is used by all of the devices on that WLAN. At 52, complete keying material may be programmed into a key storage portion of the key. In alternative implementations, partial keying material or no keying material may be programmed into the key storage portion.

The key storage portion may include either or both of reprogrammable storage and fixed storage. In one aspect, a complete fixed key may be programmed into a fixed storage of the key. In a second aspect, partial keying material may be programmed into fixed storage, with the rest of it being programmable. In a third aspect, all the keying material may be programmed into reprogrammable storage.

When the key is configured with a complete fixed key in fixed storage, the key becomes a simple, inexpensive device. The fixed key is not reprogrammable. A new cryptographic key hence requires a new key device.

When the key is configured with partial keying material or no keying material in reprogrammable storage, the security of the key may be increased, since the end user may reprogram the cryptographic key to increase the independence of the unique identifier and the cryptographic key.

At block 54, the key may be interfaced to a wireless device to send configuration information to the wireless device. The interface preferably includes a two-wire serial port to conduct signals between the key and the wireless device.

Block 56 determines the load status of the keying material. The load status includes the type of storage device and the amount of keying material. The keying material load status may be determined by the wireless device and the wireless key. Block 58 detects if complete keying material is loaded. If not, then the wireless device sends partial keying material or complete keying material to the wireless key. At 60 and 62, the key receives the keying material and generates complete keying material. At 64, the key 30 sends the configuration information including the complete keying material and the unique network identifier to the wireless device. At 66, the key is de-interfaced from the wireless device.

A number of embodiments of the invention have been described. Nevertheless, it will be understood that various modifications may be made without departing from the spirit and scope of the invention. Accordingly, other embodiments are within the scope of the following claims.

What is claimed is:

1. A key comprising:
a non-volatile memory to store network configuration information for a wireless device on a network, the network configuration information including a unique network identifier;
a configuration managing circuit, coupled to the non-volatile memory, to manage the network configuration information; and
an interface to communicate data including the network configuration information with the wireless device.

2. The key of claim 1 wherein the configuration managing circuit includes a processor.

3. The key of claim 1 further comprising a key manager to manage the network configuration information; and
wherein the non-volatile memory includes programmable memory.

4. The key of claim 3 wherein the non-volatile memory includes first partial keying material; and
the key manager operating to receive second partial keying material from the wireless device, to generate complete keying material from the first partial keying material and said second partial keying material, and to store the complete keying material in the programmable memory.

5. The key of claim 4 wherein the second partial keying material is stored in the non-volatile memory.

6. The key of claim 3 further comprising a key receiver to receive a complete key from the wireless device and to store the complete key in the programmable memory.

7. A method comprising:
interfacing a key device to a wireless device;
sending network configuration information from the key device to the wireless device, the network configuration information including a unique identifier; and
de-interfacing the key device from the wireless device after said sending.

8. The method of claim 7 wherein sending the network configuration information includes sending complete keying material.

9. The method of claim 7 further comprising determining whether the key device includes complete keying material.

10. The method of claim 9 further comprising in response to determining whether the key device includes first partial keying material;
requesting second partial keying material from the wireless device;
receiving the second partial keying material; and
generating the complete keying material from the second partial keying material.

11. The method of claim 10 wherein generating the complete keying material includes combining the first partial keying material with the second partial keying material.

12. The method of claim 11 wherein sending the network configuration information includes sending the complete keying material.

13. The method of claim 9 further comprising in response to determining the key device does not include the complete keying material:
sending first keying material from the wireless device to the key device;
receiving the first keying material; and
storing the received first keying material in non-volatile memory.

14. The method of claim 13 wherein sending the network configuration information includes sending the first keying material.

15. A method comprising:
interfacing a key device to a wireless device;
determining whether the key device includes complete keying material;
in response to determining the key device does not include the complete keying material, generating the complete keying material;
sending network configuration information from the key device to the wireless device, the network configuration information including the complete keying material; and
de-interfacing the key device from the wireless device after said sending.

16. The method of claim 15 wherein generating the complete keying material includes:
receiving second partial keying material from the wireless device; and
generating the complete keying material from the second partial keying material.

17. The method of claim 16 wherein generating the complete keying material includes requesting the second partial keying material from the wireless device.

18. The method of claim 16 wherein generating the complete keying material includes combining the second partial keying material with first partial keying material stored in the non-volatile memory.

19. The method of claim 18 further including storing the complete keying material in non-volatile memory.

20. The method of claim 19 wherein said storing further includes overwriting the first partial keying material.

21. A wireless device, comprising:
a port to interface to a key of a specified type that includes network configuration information including complete keying material; and
a key manager to communicate with the key, the key manager to receive the network configuration information from the key.

22. The wireless device of claim 21 wherein the port is a serial port.

23. The wireless device of claim 21 wherein the key manager transfers partial keying material to the key to form the complete keying material in the key.

24. The wireless device of claim 21 further comprising nonvolatile storage to store the complete keying material.

25. The wireless device of claim 24 wherein the complete keying material is a cryptographic key.

26. The wireless device of claim 24 wherein the key manager uses the complete keying material to negotiate the cryptographic key.

27. The wireless device of claim 21 wherein the network configuration information further includes a unique network identifier.

28. A network comprising:
a key including;
a non-volatile memory to store network configuration information including a unique network identifier;
a circuit coupled to the non-volatile memory to manage the network configuration information; and
an interface to communicate data including the network configuration information with a wireless device; and
the wireless device configurable by the key to operate on the network, including;
a port to interface to the key; and
a key manager to communicate with the key, the key manager to receive the network configuration information from the key.

29. The network of claim 28 wherein the wireless device port is a serial port.

30. The network of claim 28 wherein the key manager transfers partial keying material to the key to form the complete keying material in the key.

31. An article comprising a machine readable medium including machine readable instructions that when executed by a machine, cause the machine to:
determine whether a key device, interfaced to a wireless device, includes complete keying material;
in response to determining the key device does not include the complete keying material, generate the complete keying material; and
send network configuration information from the key device to the wireless device, the network configuration information including the complete keying material.

32. The article of claim 31 wherein said generate the complete keying material includes:
receive second partial keying material from the wireless device; and
generate the complete keying material from the second partial keying material.

33. The article of claim 31 wherein said generate the complete keying material includes request the second partial keying material from the wireless device.

34. The article of claim 31 wherein said generate the complete keying material includes combine the second partial keying material with first partial keying material stored in the non-volatile memory.

35. The article of claim 34 further including store the complete keying material in non-volatile memory.

36. The article of claim 35 wherein said store further includes overwrite the first partial keying material.
